(19) United States
(12) Patent Application Publication
(10) Pub. No.: US 2013/0242271 A1
(43) Pub. Date: Sep. 19, 2013

(54) PROJECTION DISPLAY DEVICE

(71) Applicant: Shinichirou Jougo, Tokyo (JP)

(72) Inventor: Shinichirou Jougo, Tokyo (JP)

(21) Appl. No.: 13/988,503

(22) PCT Filed: Dec. 10, 2010
(86) PCT No.: PCT/JP2010/072210

§ 371 Date: May 20, 2013

(51) Int. Cl. G03B 21/16

(52) U.S. Cl. CPC G03B 21/16
USPC 353/61

(57) ABSTRACT

A projection display device includes, in a case, a flow path forming member for forming a flow path through which cooling air circulates, an image forming element disposed in the flow path, a fan disposed in the flow path, a cooling element for cooling the cooling air via flow path forming member, a temperature detection element for detecting the surface temperature of flow path forming member, a temperature detection element for detecting the temperature of a space in the case, and a control unit for controlling the cooling element based on the detection results of the temperature detection elements. The control unit controls the cooling element so that the inputs from the two temperature detection elements can be identical.

### TECHNICAL FIELD

The present invention relates to a projection display device. More specifically, the invention relates to an image forming element included in the projection display device and the cooling mechanism of a member disposed around it.

### BACKGROUND ART

The projection display device includes the image forming element that modulates illumination light based on an image signal to form image light. The projection display device has a cooling mechanism to maintain the temperature of the image forming element within a predetermined range. A typical cooling mechanism includes an inlet formed in the case and a fan for introducing outside air through the inlet. Further, in the inlet, a filter is disposed to remove dust from the outside air introduced through the inlet. However, because the dust resistance performance of the filter is high, the maintenance frequency of the filter is large.

As a cooling mechanism to solve the problem, there is known a cyclical cooling mechanism. For example, Patent Literature 1 describes a cooling mechanism that includes an airtight container housing a liquid crystal panel, a fan disposed in the airtight container, and a cooling unit disposed on the side face of the airtight container. The fan causes air (refrigerant) in the airtight container to convectively flow therein. The refrigerant cools the liquid crystal panel by the process of exchanging heat with the liquid crystal panel. The refrigerant whose temperature has increased due to the process of heat exchange with the liquid crystal panel is cooled by the cooling unit to cool the liquid crystal panel again.

### CITATION LIST

Patent Literature 1: Japanese Utility Model Application Laid-Open No. 1994-002337

### SUMMARY OF INVENTION

### Problems to be Solved by Invention

The aforementioned cyclical cooling mechanism has had the following problem. That is, the refrigerant circulating in the container or a duct is cooled equal to or lower than the ambient temperature of the container or the duct. As a result, the surface temperature of the container or the duct also drops to become equal to or lower than the ambient temperature, thereby causing dew condensation on the surface of the container or the duct.

### Solution to Problem

The present invention provides a projection display device that magnifies and projects an image via a projection lens. The projection display device of the present invention includes, in a case, a flow path forming member for forming a flow path through which cooling air circulates, an image forming element disposed in the flow path, a fan disposed in the flow path, a cooling element for cooling the cooling air circulated in the flow path via the flow path forming member, a first temperature detection element for detecting the surface temperature of the flow path forming member, a second temperature detection element for detecting the temperature of a space in the case, and a control unit for controlling the cooling element based on the detection results of the first temperature detection element and the second temperature detection element. The control unit controls the cooling element so that inputs from the first temperature detection element and the second temperature detection element can be identical.

### Effect of Invention

According to the present invention, a projection display device including a cyclical cooling mechanism where no dew condensation occurs can be realized.

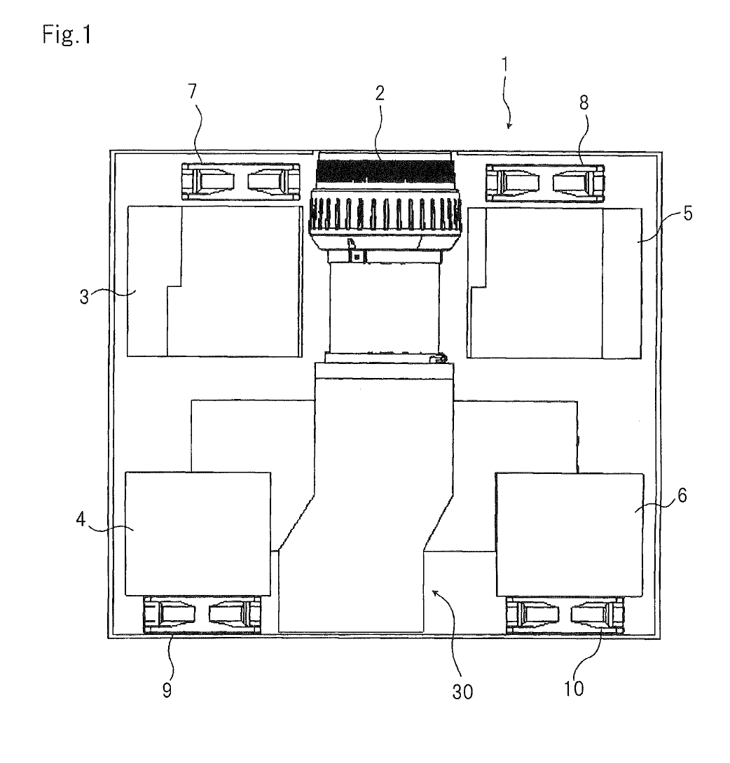

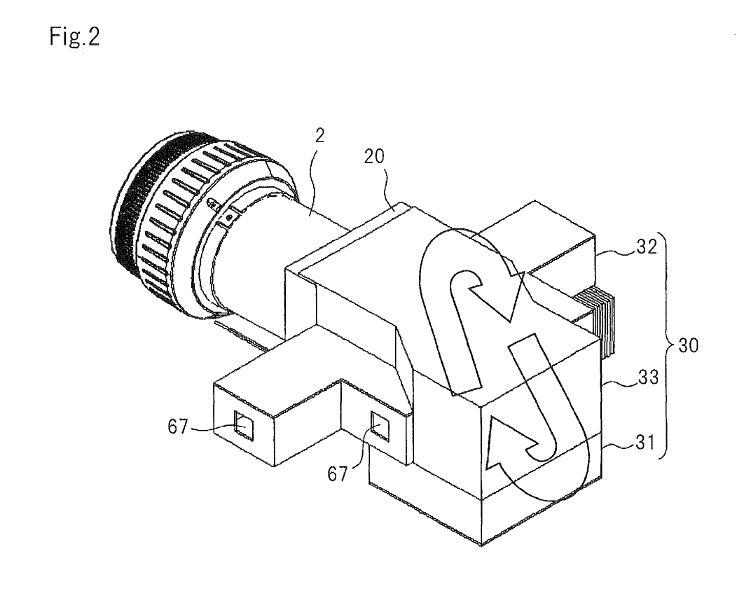

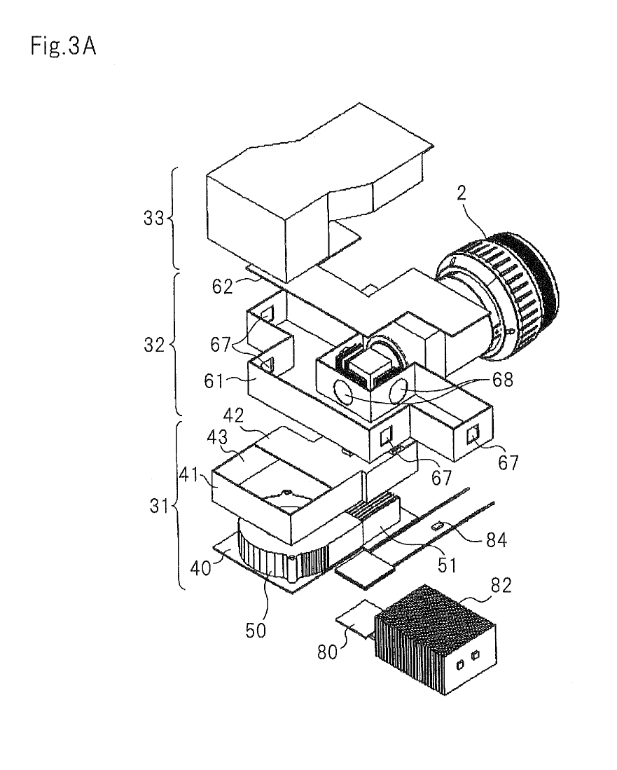

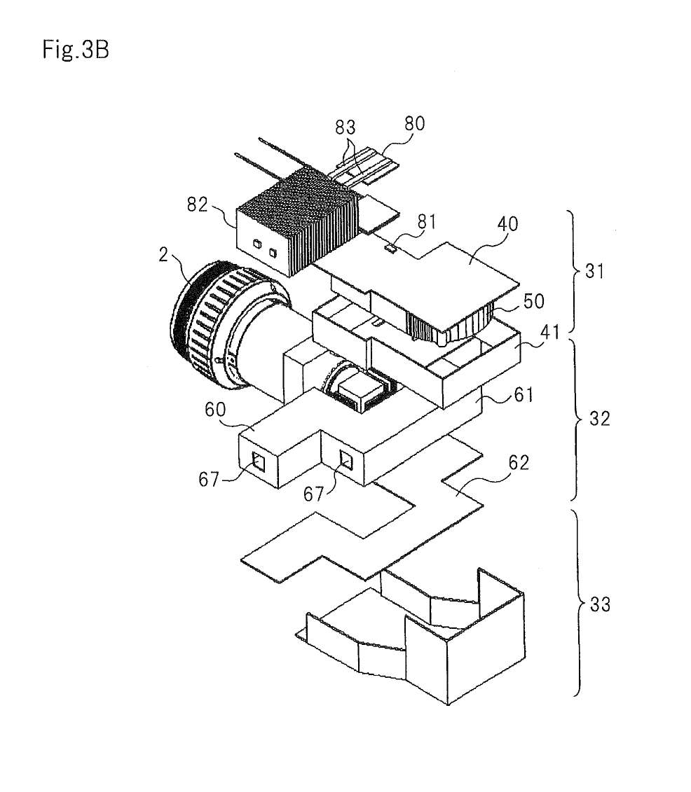

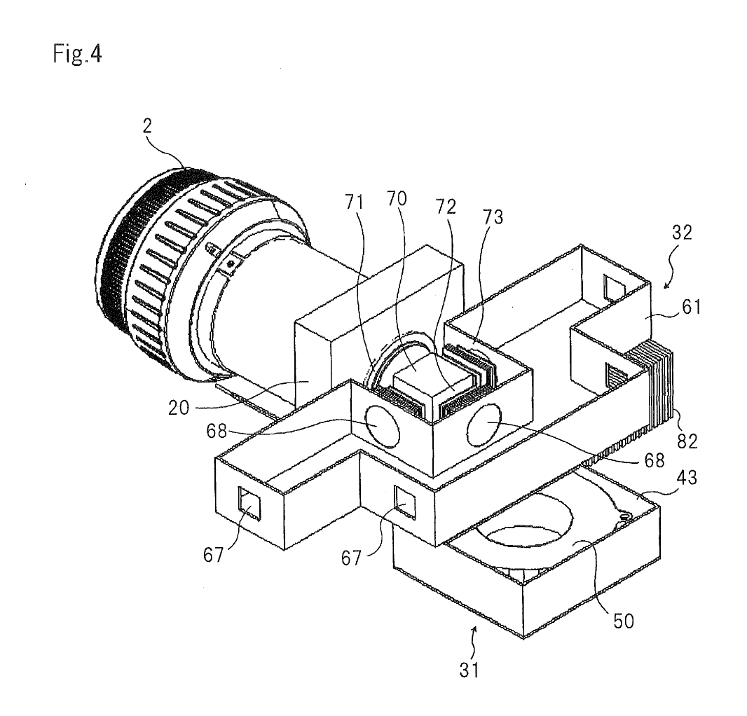

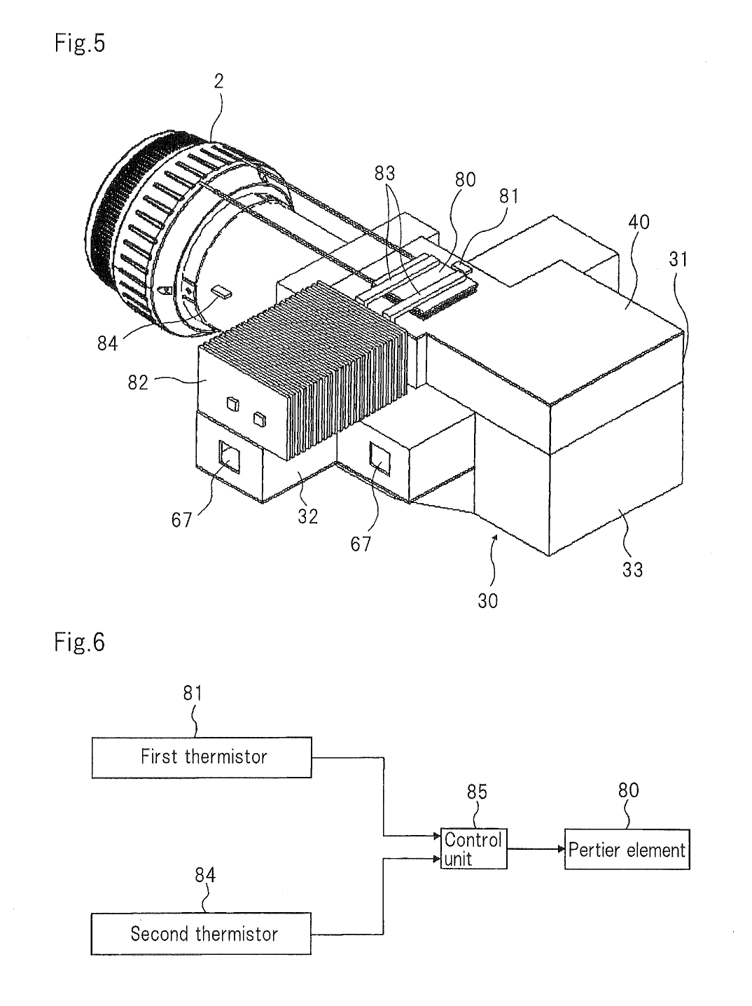

### BRIEF DESCRIPTION OF DRAWINGS

[FIG. 1] A plan view showing the internal structure of a projection display device according to the present invention.

[FIG. 2] An upper perspective view showing a projection lens, a lens holder, and a box.

[FIG. 3A] An exploded perspective view showing the box.

[FIG. 3B] An exploded perspective view showing the box.

[FIG. 4] An upper perspective view showing the box from which a cover member and the top board of a second box have been removed.

[FIG. 5] A lower perspective view showing the projection lens, the lens holder, and the box.

[FIG. 6] A control block diagram showing a Pertier element.

### DESCRIPTION OF EMBODIMENTS

Next, the embodiment of the present invention will be described with reference to the drawings. FIG. 1 is a schematic plan view showing the internal structure of a projection display device according to the embodiment. The projection display device according to the embodiment includes a case divided into a lower case and an upper case. However, in FIG. 1, the upper case is omitted to show the internal structure.

As shown in FIG. 1, projection lens 2 is disposed roughly in the center of case 1. First power source 3 and first light source 4 are arranged on the left side of projection lens 2. Second power source 5 and second light source 6 are arranged on the right side of projection lens 2. Further, axial fans 7 and 8 are respectively arranged between first power source 3 and second power source 5 and the back panel of case 1. Axial fans 9 and 10 are respectively arranged between first light source 4 and second light source 6 and the back panel of case 1. Axial fan 7 mainly cools first power source 3, and axial fan 8 mainly cools second power source 5. Axial fan 9 mainly cools first light source 4, and axial fan 10 mainly cools second light source 6.

Lens holder 20 for holding the rear end of projection lens 2 is disposed behind projection lens 2, and box 30 is disposed behind lens holder 20.

FIG. 2 is an enlarged perspective view showing projection lens 2, lens holder 20, and box 30. FIGS. 3A and 3B are exploded perspective views showing the box. As shown in FIG. 2, box 30 includes first box 31, second box 32 stacked on first box 31, and cover member 33 disposed over first box 31 and second box 32.

As shown in FIGS. 3A and 3B, first box 31 includes bottom plate 40, side plate 41, and top plate 42. Bottom plate 40 is made of metal while side plate 41 and top plate 42 are made of resins. Side plate 41 and top plate 42 are integrally formed.

As shown in FIG. 4, first box 31 includes sirocco fan 50. Specifically, as shown in FIGS. 3A and 3B, sirocco fan 50 is disposed on bottom plate 40 of first box 31 and covered with side plate 41 and top plate 42. Top plate 42 partially covers the top of first box 31. In other words, opening 43 is formed in the top of first box 31, and the inlet of sirocco fan 50 is exposed from opening 43 (refer to FIG. 4). Top plate 42 includes three outlets 44 (FIG. 3A shows only two outlets, while FIG. 3B shows only one outlet) formed to blow out air (cooling air) sent from sirocco fan 50. Further, as shown in FIG. 3A, many metal plates (aluminum plates 51) are arranged before the exhaust port of sirocco fan 50. Aluminum plates 51 are arranged at fixed intervals. The end surface of each aluminum plate 51 is in contact with the bottom plate inner surface of first box 31. The cooing air sent from sirocco fan 50 passes through adjacent aluminum plates 51 to be blown out from each outlet 44.

As shown in FIGS. 3A and 3B, second box 32 also includes bottom plate 60, side plate 61, and top plate 62. However, bottom plate 60, side plate 61 and top plate 62 of second box 32 are all made of resins. Bottom plate 60 and side plate 61 are integrally formed. Side plate 61 includes a plurality of rectangular windows 67 through which lights emitted from light sources 4 and 6 shown in FIG. 1 enter.

Second box 32 houses a plurality of optical elements (not shown) constituting a lighting optical system. As shown in FIG. 4, second box 32 is installed on first box 31. The region of side plate 61 of second box 32 facing lens holder 20 is recessed to be away from lens holder 20. As a result, installation space 63 is formed behind lens holder 20, the lower portion of installation space 63 is covered with top plate 42 (FIG. 3A) of first box 31 and the upper portion of installation space 63 is opened.

Cross dichroic prism (XDP 70) is installed in installation space 63. Further, a liquid crystal panel or a polarization plate is disposed in a gap between XDP 70 and side plate 61 of second box 32. Specifically, a red-color liquid crystal panel or the like is disposed in the gap (first gap 71) between the first incident surface of XDP 70 and the first region of side plate 61 facing the first incident surface. A green-color liquid crystal panel or the like is disposed in a gap (second gap 72) between the second incident surface of XDP 70 and the second region of side plate 61 facing the second incident surface. A blue-color liquid crystal panel is disposed in the gap (third gap 73) between the third incident surface of XDP 70 and the third region of side plate 61 facing the third incident surface. In each region of side plate 61, a circular window through which light enters from corresponding window 67, and convex lens 68 is fitted in the circular window. Further, a polarization plate is disposed on the incident side of each liquid crystal panel. On the other hand, a compensating plate and an analyzer are arranged on the exit side of each liquid crystal panel.

Installation space 63 is located above outlet 44 formed in top plate 42 of first box 31 (FIG. 3A). Accordingly, the cooling air blown out of each outlet 44 flows into installation place 63. More specifically, first gap 71 is located above first outlet 44, second gap 72 is located above second outlet 44, and third gap 73 is located above third outlet 44. Accordingly, the cooling air blown out of first outlet 44 mainly flows into first gap 71, the cooling air blown out of second outlet 44 mainly flows into second gap 72, and the cooling air blown out of third outlet 44 mainly flows into third gap 73.

Further, as shown in FIGS. 2 and 4, the upper portion of installation space 63 and opening 43 of first box 31 are connected by cover member 33. In other words, a duct constituting a part of the flow path of the cooling air is formed between installation space 63 and opening 43.

That is, the cooling air sent from sirocco fan 50 flows out of each outlet 44, and flows into installation space 63. The cooling air that flew into installation space 63 passes through installation space 63 to flow into the duct. The cooling air that flew into the duct is sucked into sirocco fan 50 via opening 43. The cooling air sucked into sirocco fan 50 is blown out again from sirocco fan 50.

As described above, in the projection display device of the embodiment, the flow path through which the cooling air circulates is formed, and a cooling target such as the liquid crystal panel or the polarization plate is formed in the midway of the flow path. Further, the flow path includes first box 31, second box 32, lens holder 20, and cover member 33. In other words, first box 31, second box 32, lens holder 20, and cover member 33 are flow path forming members constituting the flow path of the cooling air.

As shown in FIG. 5, a cooling element (Pertier element 80) and a first temperature detection element (first thermistor 81) are arranged on the outer surface of bottom plate 40 of first box 31. Heat sink 82 is disposed laterally to first box 31. Pertier element 80 and heat sink 82 are connected via heat pipe 83. However, heat sink 82 can be directly mounted on Pertier element 80. A second temperature detection element (second thermistor 84) is disposed laterally to projection lens 2.

As described above, many aluminum plates 51 are arranged before the exhaust port of sirocco fan 50 in first box 31, and the end surface of each aluminum plate 51 is in contact with the bottom plate inner surface of first box 31 (FIG. 3A). On the other hand, Pertier element 80 is in contact with the bottom plate outer surface of first box 31. In other words, aluminum plate 51 and Pertier element 80 face each other via bottom plate 40 of first box 31, and are thermally connected via bottom plate 40. Accordingly, when bottom plate 40 of first box 31 is cooled by Pertier element 80, aluminum plate 51 is cooled. When aluminum plate 51 is cooled, the cooling air that passed between adjacent aluminum plates 51 is cooled.

Next, the thermistor will be described. First thermistor 81 is in contact with the bottom plate outer surface of first box 31. Accordingly, the temperature of bottom plate 40 of first box 31 is detected by first thermistor 81. On the other hand, second thermistor 84 is not in contact with box 30. Accordingly, the ambient temperature of box 30 is detected by second thermistor 84. In the projection display device of the embodiment, Pertier element 80 is controlled based on the temperatures detected by two thermistors 81 and 84.

FIG. 6 is a control block diagram showing Pertier element 80. The projection display device of the embodiment includes control unit 85 for controlling Pertier element 80. The outputs of first thermistor 81 and second thermistor 84 are input to control unit 85. Control unit 85 controls Pertier element 80 so that the input from first thermistor 81 and the input from second thermistor 84 can be identical. In other words, Pertier element 80 is controlled so that the temperature of bottom plate 40 of first box 31 and the ambient temperature can be equal.

By controlling Pertier element 80 as described above, the temperature of bottom plate 40 of first box 31 is maintained roughly equal to the ambient temperature (e.g., ambient temperature +5° C.), thereby preventing dew condensation.

As described above, first box 31, second box 32, lens holder 20, and cover member 33 are flow path forming members constituting the flow path of the cooling air. Among the flow path forming members, only bottom plate 40 of first box 31 is made of metal. Pertier element 80 is disposed on bottom plate 40 of first box 31. In other words, among the flow path forming members, the temperature of bottom plate 40 of first box 31 is lowest. Thus, as long as the temperature of bottom plate 40 of first box 31 is maintained roughly equal to the ambient temperature, dew condensation in the entire flow path forming members is prevented.

Since Pertier element 80 is disposed on bottom plate 40 of first box 31, even when the flow path forming members other than the bottom plate of first box 31 are made of metal, the temperature of bottom plate 40 is lowest. Thus, the aforementioned effects can be provided even when the members other than the bottom plate of first box 31 are made of metal. Further, when many portions of the flow path forming members are made of metal, the improvement of cooling effects can be expected.

The exemplary embodiment of the present invention has been described. However, the present invention is not limited to the embodiment. For example, the cooling element is not limited to the Pertier element, and the temperature detection element is not limited to the thermistor. The first temperature detection element only needs to be installed at a position where the surface temperature of the flow path forming member can be detected. The second temperature detection element only needs to be installed at a position where the temperature of the space in the case can be detected. For example, when a temperature sensor having a sensing unit and a body separated from each other is used as a first temperature detection element, the sensing unit only needs to be disposed on the surface of the flow path forming member. When a similar temperature sensor is used as a second temperature detection element, a body can be in contact with the flow path forming member as long as a sensing unit is not in contact with the flow path forming member.

1. A projection display device that magnifies and projects an image via a projection lens, comprising, in a case:
a flow path forming member for forming a flow path through which cooling air circulates;
an image forming element disposed in the flow path;
a fan disposed in the flow path;
a cooling element for cooling the cooling air circulated in the flow path via the flow path forming member;
a first temperature detection element for detecting a surface temperature of the flow path forming member;
a second temperature detection element for detecting a temperature of a space in the case; and
a control unit for controlling the cooling element based on detection results of the first temperature detection element and the second temperature detection element,
wherein the control unit controls the cooling element so that inputs from the first temperature detection element and the second temperature detection element can be identical.

2. The projection display device according to claim 1, wherein at least a part of the flow path forming member comprises metal, and the cooling element and the first temperature detection element are in contact with the metal portion of the flow path forming member.

3. The projection display device according to claim 1, wherein:
the flow path forming member includes a first box hosing the fan, a second box housing a lighting optical system for guiding light to the image forming element, a cover member disposed over the first box and the second box, and a lens holder for holding the projection lens;
the first box includes an opening that is connected to an inlet of the fan, and an outlet for blowing out air sent from the fan;
between the second box and the lens holder, an installation space is formed to be communicated with the outlet;
the image forming element is disposed in the installation space; and
the cover member connects the installation space and the opening of the first box with each other.

4. The projection display device according to claim 3, wherein:
a bottom plate of the first box comprises a metal plate; and
the cooling element and the first temperature detection element are in contact with an outer surface of the bottom plate.

5. The projection display device according to claim 1, further comprising a heat sink thermally connected to the cooling element.

6. The projection display device according to claim 5, wherein the cooling element and the heat sink are thermally connected to each other via a heat pump.

7. The projection display device according to claim 1, wherein:
the cooling element comprises a Peltier element; and
one detection element selected from a group of the first temperature detection element and the second temperature detection element comprises a thermistor.

8. The projection display device according to claim 2, wherein:
the flow path forming member includes a first box hosing the fan, a second box housing a lighting optical system for guiding light to the image forming element, a cover member disposed over the first box and the second box, and a lens holder for holding the projection lens;
the first box includes an opening that is connected to an inlet of the fan, and an outlet for blowing out air sent from the fan;
between the second box and the lens holder, an installation space is formed to be communicated with the outlet;
the image forming element is disposed in the installation space; and
the cover member connects the installation space and the opening of the first box with each other.

9. The projection display device according to claim 8, wherein:
a bottom plate of the first box comprises a metal plate; and
the cooling element and the first temperature detection element are in contact with an outer surface of the bottom plate.

10. The projection display device according to claim 9, further comprising a heat sink thermally connected to the cooling element.

11. The projection display device according to claim 10, wherein the cooling element and the heat sink are thermally connected to each other via a heat pump.

12. The projection display device according to claim 11, wherein:
the cooling element comprises a Peltier element; and
one detection element selected from a group of the first temperature detection element and the second temperature detection element comprises a thermistor.
